(19) United States
(12) Patent Application Publication
(10) Pub. No.: US 2021/0076574 A1
(43) Pub. Date: Mar. 18, 2021

(54) PLANT GROWING APPARATUS

(71) Applicant: High Caliper Growing, Inc., Oklahoma City, OK (US)

(72) Inventor: Kurt E. Reiger, Oklahoma City, OK (US)

(21) Appl. No.: 16/569,037

(22) Filed: Sep. 12, 2019

(51) Int. Cl. A01G 9/02; B65D 25/14

(52) U.S. Cl. CPC A01G 9/02; B65D 25/14

(57) ABSTRACT

A plant growing apparatus is provided for growing a plant in a container having vents. The plant growing apparatus comprises a container and a fabric liner having a plurality of pores. The container has an interior defined by a bottom and at least four sidewalls and one or more vents in the bottom and the at least four sidewalls. The fabric liner is positioned within the container and configured into a shape generally corresponding to the container. The fabric liner has a fabric bottom and at least four upwardly projecting fabric sidewalls. Each of the plurality of pores has a diameter less than one millimeter.

### TECHNICAL FIELD

The present disclosure relates generally to plant growing apparatus, and, more particularly, to plant growing containers with fabric liners configured to retain growing medium and root prune.

### BACKGROUND

Growing plants in household items is becoming exceedingly common. For example, plants are grown in colanders, tin cans, tea pots, muffin tins, old sinks, and plastic bottles. Plants may also be grown in other common containers or crates around the house. For example, plants may be grown in a milk crate. Milk crates are durable and often made of hard plastic, metal, galvanized metal, or wood. Milk crates also come in a variety of colors and can be used as décor in a room such as an apartment, college dormitory, home, or office. The sturdiness of a milk crate creates a desirable container for growing plants. However, milk crates and other common containers and crates typically have vents in the bottom and sides, commonly constructed with interwoven slats about an inch or two apart.

Vented containers and crates, such as milk crates, are sturdy and durable, but have deficiencies when attempting to grow plants. The large open vents between the interwoven slats create issues with retaining soil, or other growing medium. To successfully grow a plant in a vented container or crate, a liner is required. For example, the liner may be newspaper or flexible plastic. Newspaper is a temporary solution for retaining soil as the newspaper rots over time allowing soil to flow out of the container or crate. Flexible plastic retains too much moisture which negatively affects plant growth. If holes are punched in the flexible plastic to aid in the moisture issue, growing medium and water flows out of the container or crate through the holes. These deficiencies prompt the need for a liner that retains growing medium while also being porous.

### SUMMARY

In accordance with the present invention, a plant growing apparatus is provided which overcomes the deficiencies described above, and has other advantages.

In one embodiment, a plant container is provided. The plant container comprises a fabric liner having a plurality of pores. The fabric liner is configured into a container having a bottom and four upwardly projecting sidewalls. The container has a sufficient rigidity to retain growing medium within its interior. To provide sufficient porosity to permit transfer of air and water through the bottom and the upwardly projecting sidewalls, each of the pores has a diameter less than one millimeter.

In another embodiment, a plant growing apparatus is provided. The plant growing apparatus comprises a container and a fabric liner having a plurality of pores. The container has an interior defined by a bottom and at least four sidewalls with vents in the bottom and the at least four sidewalls. In some embodiments, the container is a milk crate. Positioned within the container is the fabric liner. The fabric liner lines the interior of the container and is configured into a shape which conforms substantially to the interior of the container. The fabric liner has a fabric bottom and at least four upwardly projecting fabric sidewalls. Each of the pores throughout the fabric liner has a diameter less than one millimeter.

### BRIEF DESCRIPTION OF THE DRAWINGS

The drawings included with this application illustrate certain aspects of the embodiments described herein. However, the drawings should not be viewed as exclusive embodiments. The subject matter disclosed is capable of considerable modifications, alterations, combinations, and equivalents in form and function, as will occur to those skilled in the art with the benefit of this disclosure.

FIG. 1 is a top perspective view of a plant growing apparatus in accordance with one embodiment of the present disclosure.

FIG. 2 is a bottom perspective view of a plant growing apparatus in accordance with one embodiment of the present disclosure.

FIG. 3 is a top perspective view of the fabric liner of a plant growing apparatus in accordance with one embodiment of the present disclosure.

FIG. 4 is a top view of a plant growing apparatus in accordance with one embodiment of the present disclosure.

FIG. 5 is a cross-sectional side view of a plant growing apparatus in accordance with one embodiment of the present disclosure.

FIG. 6 is a top perspective view of a plant growing apparatus with the fabric liner folded over the sidewalls of the container in accordance with one embodiment of the present disclosure.

### DETAILED DESCRIPTION

The present disclosure may be understood more readily by reference to these detailed descriptions. For simplicity and clarity of illustration, where appropriate, reference numerals may be repeated among the different figures to indicate corresponding or analogous elements. In addition, numerous specific details are set forth in order to provide a thorough understanding of the various embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

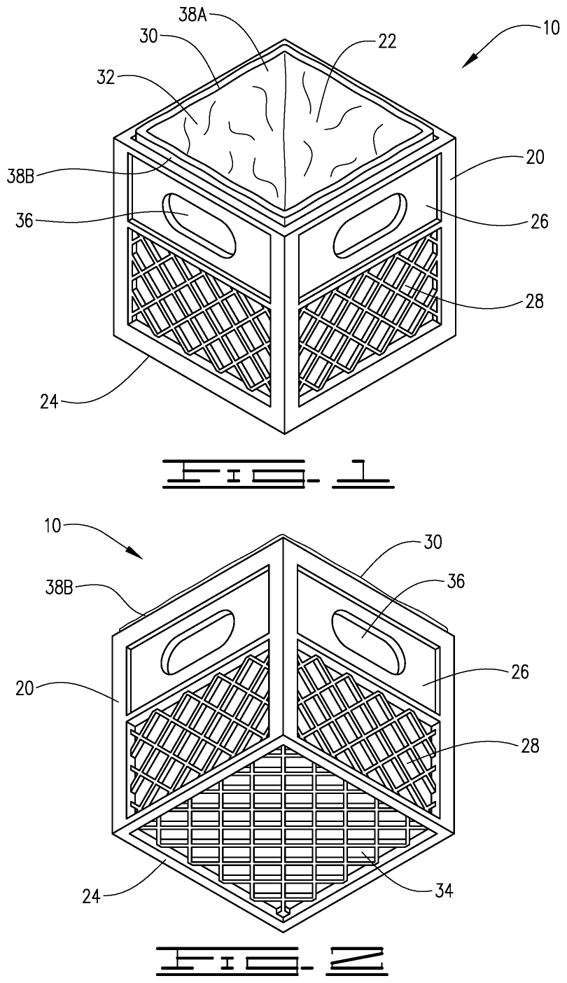

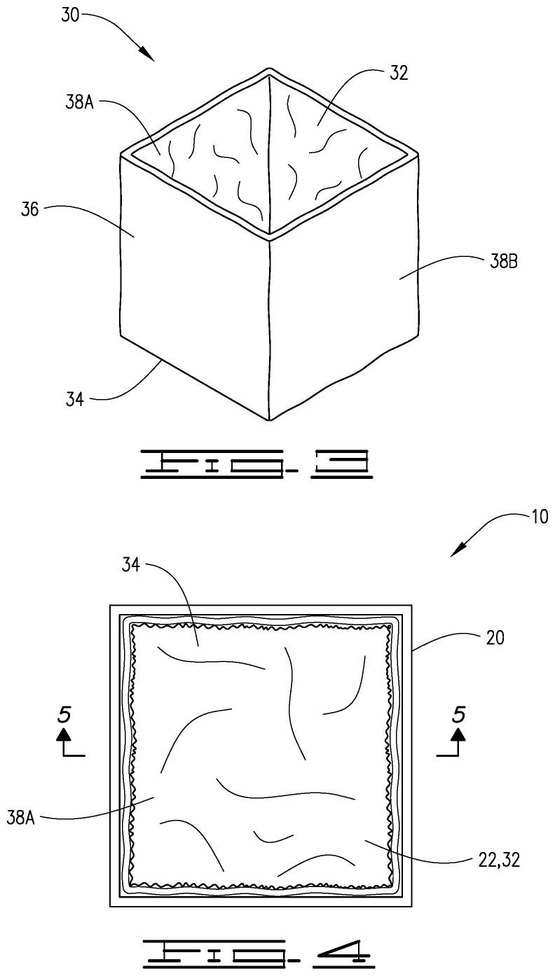

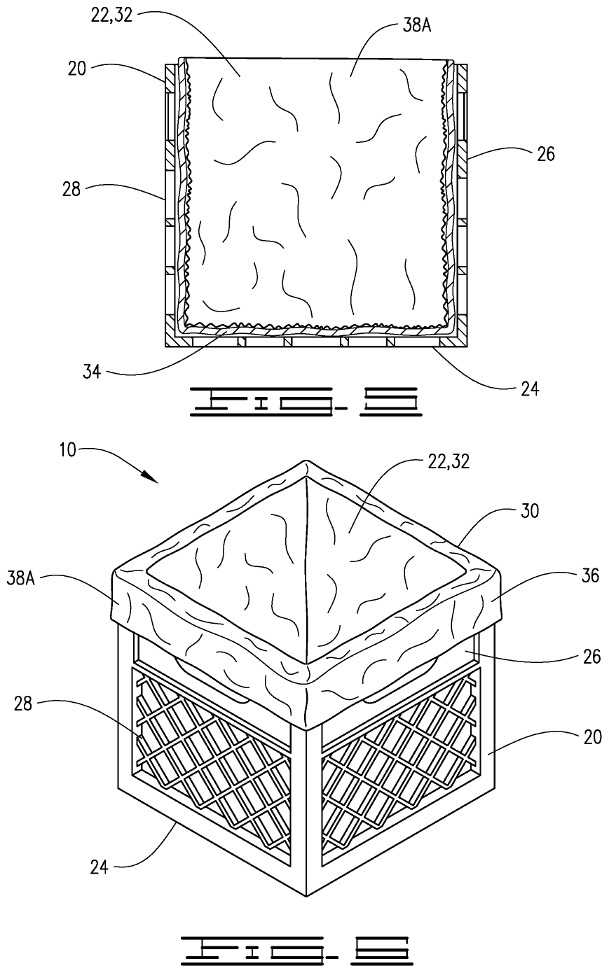

Referring now to FIGS. 1-6 generally, the plant growing apparatus of the present disclosure is illustrated and generally designated by the numeral 10. As shown by the drawings, the general form of plant growing apparatus 10 includes a container 20 and a fabric liner 30 positioned within container 20. To provide for fluid movement through fabric liner 30, fabric liner 30 has a plurality of pores. Container 20 has an interior 22 defined by a bottom 24 and at least four sidewalls 26. One or more vents 28 are dispersed throughout bottom 24 and sidewalls 26. An example of a suitable container 20 is a milk crate as shown in FIGS. 1-2 and 4-6. A typical milk crate has dimensions of 12″ long by 12″ wide by 10.5″ tall defining a volume of about 24.78 liters. Another conventional size for a milk crate might be 18″ long by 12″ wide by 10.5″ tall defining a volume of about 37.17 liters. Fabric liner 30 ensures soil and other media are retained within container 20.

In some embodiments, container 20 is comprised of a rigid material. The rigid material allows one or more of container 20 to be stacked on top of one another without container 20 bending or flexing. For example, hard plastic, metal, galvanized metal, or wood are suitable rigid materials for container 20.

Fabric liner 30 lines interior 22 of container 20 to restrict the loss of soil and other media through vents 28 of container 20. Fabric liner 30 comprises a fabric interior 32 defined by a fabric bottom 34 and at least four upwardly projecting fabric sidewalls 36. Fabric bottom 34 and fabric sidewalls 36 have inner surfaces 38A and outer surfaces 38B. Fabric bottom 34 and fabric sidewalls 36 may be formed from a single piece of fabric or from two or more pieces of fabric. In some embodiments, the type of fabric used for fabric bottom 34 may be different than the fabric used for fabric sidewalls 36.

Typically, fabric liner 30 is a non-biodegradeable fabric. The plurality of pores throughout fabric liner 30 provide air and water permeability through fabric liner 30. Pores having diameters no larger than one millimeter in diameter will provide the desired air and water permeability while also providing the desired retention of soil and other media within fabric interior 32 of fabric liner 30. Fluid permeability allows fabric liner 30 to release heat buildup, while also permitting moisture movement through fabric liner 30. These characteristics allow plant components to breathe while in fabric interior 32.

Suitable types of fabric for fabric liner 30 include porous, non-woven, needle-punched fabrics. The porous, non-woven, needle-punched fabrics are comprised of fibers which are tangled and knotted as a result of being needle punched. This creates a rough or fuzzy surface capable of trapping, or catching plant roots, but restricts and curtails penetration of the fabric by the roots. In some embodiments, outer surface 38B of fabric bottom 34 and fabric sidewalls 36 has been heat bonded to create a smooth surface which provides stiffness to fabric bottom 34 and fabric sidewalls 36. In such embodiments, inner surfaces 38A of fabric bottom 34 and fabric sidewalls 36 remain rough or fuzzy, such that the roots of a growing plant may be trapped and directed back into fabric interior 32.

A suitable type of needle punched fabric for fabric liner 30 is formed of staple cut fibers. The fabric is formed using fibers of polyolefin, polyester, polyamide or mixtures thereof. A staple cut fiber fabric suitable for use as fabric liner 30 may be a heavy, for example about 203.43 grams per meter squared or heavier, fabric formed of polypropylene staple fibers which is strongly heat bonded on one side. For example, non-woven staple-cut polypropylene is a suitable fabric for fabric liner 30.

Heavy needle punched fiber fabrics formed of continuous fibers are also suitable as fabric liner 30. For example, non-woven needle-punched fabrics formed of continuous polyolefin fibers, polyester fibers and/or polyamide fibers can be used such as non-woven polypropylene. As in the case of staple fiber fabrics, the continuous fiber fabrics are preferably about 203.43 grams per meter squared or heavier and are fused by heating after being tangled and knotted by needle punching. The heavier, fused fabric provides strength for resisting root penetration and for resisting the enlargement of those roots that do penetrate the material.

Another material suitable for use as fabric liner 30 is formed of woven continuous fibers. The woven continuous fibers form a substrate and, prior to being needle punched, one or more layers of staple fibers are placed on the substrate. The staple fibers and substrate are then needle punched, whereby the staple fibers are attached to one side of the substrate forming a highly rough or fuzzy surface thereon.

In some embodiments, fabric liner 30 is comprised of a heavy fabric which has been tangled and knotted by needle punching. The tangled and knotted fabric increases strength of the fabric and promotes root pruning. For example, the mass of the fabric may range from about 67.81 grams per meter squared to about 508.59 grams per meter squared. Some of the root tips growing within fabric interior 32 will not penetrate fabric liner 30 and will root prune or laterally branch when the mass of the fabric used for fabric liner 30 is within such range. Other roots may slightly penetrate fabric liner 30 and become exposed to the atmosphere. These roots will air root prune, branching laterally inside fabric interior 32. Increased strength can be imparted to fabric liner 30 by heat bonding the fibers on outer surfaces 38B. Because the roots are captured by fabric liner 30, the apical dominance of the roots that encounter fabric liner 30 is stopped, and lateral root branching, or root pruning, will occur within fabric interior 32. A fibrous root system within fabric interior 32 is created. Because of the root branching, which takes place in fabric interior 32, the plant, if transplanted, will re-establish itself and anchor itself quickly and effectively.

In some embodiments, the mass of the fabric used for fabric bottom 34 and fabric sidewalls 36 is the same. In other embodiments, the mass of the fabric used for fabric bottom 34 is greater than the mass of the fabric used for fabric sidewalls 36. Greater mass in the fabric used for fabric bottom 34 allows for a more defined and structured fabric bottom 34.

In some embodiments, as shown in FIGS. 1, 4, and 5, sidewalls 26 of container 20 and fabric sidewalls 36 are about the same length. In other embodiments, as shown in FIG. 6, the length of fabric sidewalls 36 is greater than the length of sidewalls 26 of container 20. For example, length of fabric sidewalls 36 may be two or more inches longer than sidewalls 26 of container 20. The increased length of fabric sidewalls 36 allows for fabric sidewalls 36 to be folded over sidewalls 26 of container 20 to provide a more secure, snug interaction between fabric liner 30 and container 20. Additionally, the longer fabric sidewalls 36 prevent fabric liner 30 from collapsing into itself as growing medium is poured and plants placed into plant growing apparatus 10.

Although the disclosed invention has been shown and described in detail with respect to a preferred embodiment, it will be understood by those skilled in the art that various changes in the form and detailed area may be made without departing from the spirit and scope of this invention as claimed. Thus, the present invention is well adapted to carry out the object and advantages mentioned as well as those which are inherent therein. While numerous changes may be made by those skilled in the art, such changes are encompassed within the spirit of this invention as defined by the appended claims.

What is claimed is:

1. A plant container comprising:
a first fabric, the fabric having a bottom and four upwardly projecting sidewalls forming a container; and
a plurality of pores throughout the first fabric, each of the plurality of pores having a diameter less than one millimeter,
wherein the container has sufficient rigidity to retain growing medium within an interior of the container defined by the bottom and the four upwardly projecting sidewalls.

2. The plant container of claim 1, wherein the first fabric is non-biodegradable.

3. The plant container of claim 1, wherein the first fabric is selected from the group consisting of non-woven polypropylene and non-woven staple-cut polypropylene.

4. The plant container of claim 1, wherein the first fabric has a mass which may range from about 67.81 grams per square meter to about 508.59 grams per square meter.

5. The plant container of claim 1, the container having a volume of about 24.78 liters.

6. The plant container of claim 1, the container having a volume of about 37.17 liters.

7. The plant container of claim 1, the bottom having a first length and at least one of the four upwardly projecting sidewalls having a second length, wherein the second length is greater than the first length.

8. The plant container of claim 1, wherein the bottom and the four upwardly projecting sidewalls are formed from a single piece of the first fabric.

9. The plant container of claim 1, wherein the bottom is comprised of the first fabric having a first mass and the four upwardly projecting sidewalls are comprised of a second fabric having a second mass, the second fabric having a plurality of pores throughout, each of the plurality of pores having a diameter less than one millimeter, and wherein the first mass is greater than the second mass.

10. The plant container of claim 1, each of the bottom and the four upwardly projecting sidewalls having an interior surface, wherein the interior surface has a plurality of tangled and knotted fibers suitable for entangling plant roots and preventing root circling.

11. A plant growing apparatus comprising:
a container having an interior defined by a bottom and at least four sidewalls, the container having one or more vents in the bottom and the at least four sidewalls;
a fabric liner positioned within the container, the fabric liner having a fabric bottom and at least four upwardly projecting fabric sidewalls lining the interior of the container; and
a plurality of pores throughout the fabric liner, each of the plurality of pores having a diameter less than one millimeter,
wherein the fabric liner has sufficient rigidity to retain growing medium within an interior of the fabric liner defined by the fabric bottom and the four upwardly projecting fabric sidewalls.

12. The plant growing apparatus of claim 11, wherein the container is a milk crate.

13. The plant growing apparatus of claim 11, wherein the fabric liner is comprised of a fabric that is non-biodegradable.

14. The plant growing apparatus of claim 11, wherein the fabric liner is comprised of a fabric selected from the group consisting of non-woven polypropylene and non-woven staple-cut polypropylene.

15. The plant growing apparatus of claim 11, wherein the fabric liner is comprised of a fabric having a mass which may range from about 67.81 grams per meter squared to about 508.59 grams per meter squared.

16. The plant growing apparatus of claim 11, the container having a volume of about 24.78 liters.

17. The plant growing apparatus of claim 11, the container having a volume of about 37.17 liters.

18. The plant growing apparatus of claim 11, wherein the at least four upwardly projecting fabric sidewalls have a first length and the at least four sidewalls of the container have a second length, and wherein the first length is longer than the second length.

19. The plant growing apparatus of claim 11, wherein the fabric bottom and the at least four upwardly projecting fabric sidewalls are formed from a single piece of the fabric.

20. The plant growing apparatus of claim 11, wherein the fabric bottom is comprised of a first fabric having a first weight and the at least four upwardly projecting fabric sidewalls are comprised of a second fabric having a second weight, the second fabric having a plurality of pores throughout, each of the plurality of pores having a diameter less than one millimeter, and wherein the first weight is greater than the second weight.

21. The plant growing apparatus of claim 11, each of the fabric bottom and the at least four upwardly projecting fabric sidewalls having an interior surface, wherein the interior surface has a plurality of tangled and knotted fibers suitable for entangling plant roots and preventing root circling.

22. The plant growing apparatus of claim 11, wherein the container is comprised of a rigid material.

23. The plant growing apparatus of claim 22, wherein the rigid material is selected from the group consisting of plastic, metal, galvanized metal, and wood.
